(19) United States
(12) Patent Application Publication
(10) Pub. No.: US 2026/0160775 A1
(43) Pub. Date: Jun. 11, 2026

(54) PIPETTE TIP AND MOUNTING SHAFT WITH STAGGERED OFFSET LOCKING FEATURE

(71) Applicant: Integra Biosciences AG, Zizers (CH)

(72) Inventor: Kyle R. DelloRusso, Derry, NH (US)

(73) Assignee: Integra Biosciences AG, Zizers (CH)

(21) Appl. No.: 19/408,972

(22) Filed: Dec. 4, 2025

Related U.S. Application Data
(60) Provisional application No. 63/728,955, filed on Dec. 6, 2024.

(51) Int. Cl. G01N 35/04; B01L 3/02

(52) U.S. Cl. CPC G01N 35/04; B01L 3/0275; G01N 2035/0434

(57) ABSTRACT

A pipette tip mounting shaft has a locking portion with a stop for collar of a pipette tip and four locking lobes in staggered pairs above the stop. When mounting the tip, a locking ring on the collar engages the first pair of lobes and clears the lobe peaks, then engages the second pair of lobes and clears the lobe peaks. Then the mounting shaft engages a seal on the pipette tip, and finally the stop on the mounting shaft engages a shoulder on the pipette tip between the collar and the barrel of the pipette tip. The configuration results in reduced insertion forces while also providing a stable fit for the disposable pipette tip on the mounting shaft

### CROSS-REFERENCE TO RELATED APPLICATION

The present application claims priority of U.S. Provisional Patent Application No. 63/728,955, filed December 6, 2024, the content of which is incorporated herein by reference in its entirety.

### FIELD OF THE INVENTION

The invention relates to improvements in handheld pipettes and automated liquid handling systems. More specifically, the invention relates to the configuration of disposable pipette tips and mounting shafts and provides robust sealing engagement with low insertion forces while maintaining mounted pipette tips secure and stable on the respective mounting shaft during use.

### BACKGROUND OF THE INVENTION

The use of disposable pipette tips with handheld pipettors and automated liquid handling systems is well known. Disposable pipette tips enable repeated use of pipetting systems to transfer liquid reagents or liquid samples without carryover contamination. Disposable pipette tips are typically formed of a plastic material, such as polypropylene, and have a hollow, elongated, generally conical shape. The upper end of the pipette tip typically includes a collar that is mounted to a mounting shaft on the pipetting device. The mounting shaft is sometimes called the tip fitting. The mounting shaft or tip fitting includes an internal bore through which air is displaced in order to aspirate a liquid sample or reagent into the barrel of the pipette tip and then dispense the liquid sample or reagent from the pipette tip normally in another location. The distal end of the pipette tip has a small opening through which the liquid sample or reagent is received as it is aspirated into the barrel of the pipette tip and then dispensed.

Disposable pipette tips have historically relied on tapered fits between the mounting shaft and the pipette collar, as well as sealing rings on the inside circumference of the pipette collar, to secure and seal the pipette tips to the mounting shaft. Sometimes an O-ring on the mounting shaft is used to seal against the pipette tip. With tapered fits, the seal between the mounting shaft and the disposable tip is achieved by pushing the tapered mounting shaft into the tapered collar until the mounting shaft wedges into the tip. At this point, a seal is reached between the frustoconical tip collar and the mounting shaft as a result of crushing a sealing ring on the pipette tip (or an O-ring on the mounting shaft) and/or stretching the diameter of the pipette tip.

In addition to achieving a proper seal, it is also important that the position and orientation of the mounted pipette tip be stable in the face of lateral momentum or slight knocking forces that are typical during normal use such as during touch-off against the sidewall of a sample container. In order to assure tip stability, users tend to jam the mounting shaft into the collar of the tip with excessive force. With handheld pipettes, using excessive force repeatedly to mount and eject pipette tips is not desired for ergonomic reasons. Reducing insertion forces and ejection forces are particularly important in multi-channel, handheld pipettes. It is also desired to minimize insertion and ejection forces in automated liquid handling systems, which often are configured to mount and eject 96 or 384 pipettes tips contemporaneously. Reducing the insertion forces and the ejection forces can reduce the size of the motor drives used in automated liquid handling systems, reduce the system deformation, improve the tip z-position accuracy, and otherwise improve the reliability of such systems. For example, reducing insertion forces enables automated tip racks to be constructed with less plastic and still maintain sufficient structural integrity when mounting the tips. A known issue with automated systems is that the insertion forces can cause the tip rack to bend if it is not sturdy enough to withstand the pressure of simultaneously mounting 96 or 384 pipette tips. This kind of deformation can lead to some of the tips not being mounted to the correct height on the fitting, and possibly not sufficiently to seal properly and/or maintain vertical alignment.

Various systems have been devised to provide proper sealing and stability without requiring excessive insertion and ejection forces. The assignee of the present application has developed a reliable, ergonomic pipette tip mounting system described generally in U.S. Patent No. 7,662,343 entitled "Locking Pipette Tip and Mounting Shaft," issuing on February 16, 2010; U.S. Patent No. 7,662,344, also issuing on February 12, 2010 and entitled "Locking Pipette Tip and Mounting Shaft;” U.S. Patent No. 8,277,757 entitled “Pipette Tip Mounting Shaft” and issuing on October 2, 2012; U.S. Patent No. 8,501,118 entitled “Disposable Pipette Tip” and issuing on August 6, 2013; U.S. Patent No. 8,877,513 entitled “Method of Using a Disposable Pipette Tip” and issuing on November 4, 2014; and U.S. Patent No. 9,333,500 entitled “Locking Pipette Tip and Mounting Shaft in a Handheld Manual Pipette” and issuing on May 1, 2016, all incorporated herein by reference. The assignee of the present application has also filed U.S. Pat. Appl. No. 18/601,304, entitled “Pipette Tip and Mounting Shaft,” and U.S. Pat. Appl. No. 18/601,382, entitled “Pipette Tips and Rack System for Liquid Handling Equipment,” which are also incorporated by reference. In these incorporated patents and patent applications owned by the assignee, the tip mounting shaft includes a locking section having circumferentially spaced outwardly extending locking lobes located above a stop which consists of a step spanning between the locking section of the mounting shaft and a lower sealing section of the mounting shaft having a smaller diameter. When the mounting shaft is fully inserted into the collar of a mating disposable pipette tip, the collar of the tip locks onto the mounting shaft. The bore of the pipette tip includes a circumferential shelf or shoulder separating its upper collar from the tip sealing area which is located on the circumferential shelf in more recent designs or below in the barrel of the tip in older designs. The tip collar preferably includes a locking ring at or near the upper opening of the collar through which the mounting shaft is inserted. The dimensions of the collar, and in particular the distance between the circumferential shoulder and the locking ring, are selected to match the dimensions of the mounting shaft between the stop and a catch surface of the upper end of the locking lobes, thus locking the pipette tip in a secure, reliable position and orientation. The locking lobes include an inclining ramp portion that generally flexes and distorts the pipette tip collar out of round as the mounting shaft is inserted into the pipette tip, rather than stretching the tip collar, thereby reducing the amount of insertion force needed to mount the tip.

The tip mounting shaft has three lobes spaced equally around the mounting shaft with recessed relief portions spanning between the lobes to accommodate inward distortion of the tip collar between the lobes. Using four equally spaced lobes is possible; however, testing has shown that the three-lobe configuration has lower insertion forces if all other conditions are the same. As mentioned, the lobes include an inclining ramp that gently slopes between 10-20° with respect to the vertical axis of the mounting shaft. Each lobe extends outward along the ramp towards the top of the locking section of the mounting shaft to a peak. In commercial embodiments, the lobes have a declining ramp past the peak of the lobe which reduces the required ejection force compared to an abrupt catch surface. When the mounting shaft is fully inserted into the pipette tip, the locking ring on the pipette collar engages the declining ramps as it is fitted over the peaks of the lobes, thereby providing a secure, snapped-on mount with the collar being slightly out of round. The peak of each lobe is preferably slightly rounded to facilitate removal of the pipette tip.

While the collar of the pipette tip is flexed and distorted out-of-round when the lobed mounting shaft is inserted into the pipette tip, the circumferential shoulder on the pipette tip between the collar and the barrel has sufficient structural rigidity to remain round and isolates the region at the upper end of the barrel from distortion. The structural isolation provided by the circumferential shoulder of the tip facilitates reliable sealing engagement between the lower sealing section of the tip mounting shaft and the sealing region in the upper end of the tip barrel in the incorporated issued patents, or in the case of the pending incorporated applications engagement with a reverse cup seal located at the circumferential shoulder. In some prior art tips, a sealing ring on the pipette tip extends inward from the upper end of the tip barrel below the circumferential shoulder and engages a sealing region on the mounting shaft below the stop with an interference fit. In other prior art tips, the mounting shaft includes a groove below the stop that holds an elastomeric O-ring which engages the sealing region at the top of the tip barrel when the mounting shaft is fully inserted into the tip. The O-ring is typically used to reduce the required insertion forces of larger tips that generally require higher insertion forces than smaller tips when a sealing ring on the barrel of the tip is used. In the pipette tips described in the incorporated, co-pending patent applications, a reverse cup seal is located at the circumferential shoulder on the tip, and the mounting shaft can include an O-ring or not depending on the size of the pipette tip. The present invention can be applied to pipette tips having any of these sealing arrangements.

As described in the above incorporated patents and applications owned by assignee, the combination of the locking lobes and the stop on the mounting shaft results in an ergonomic, over-center locking engagement that provides acoustic and tactile feedback to the user of a handheld pipette indicating that the disposable pipette tip is approaching and has been fully engaged on the mounting shaft. As the mounting shaft is pushed into the tip collar, the first point of contact is where the leading edge of the mounting shaft, i.e., the lower sealing section, enters through the circumferential shoulder in the pipette tip and contacts the sealing region in the tip barrel, or in the case of the pending applications contacts the reverse cup seal at the circumferential shoulder. As the mounting shaft is further depressed into the pipette tip bore, the interference for the seal increases and the inclining ramp areas of the locking lobes on the mounting shaft engage the tip collar, and in particular the locking ring around the opening of the tip collar, to distort the upper portion of the collar out-of-round. While the overall insertion force is relatively light and ergonomic compared to tip fittings with different configurations, the force increases noticeably and provides tactile feedback to the user that the tip is almost fully mounted. Insertion force is generally required until the stop member on the mounting shaft engages the circumferential shoulder on the pipette tip to abruptly stop further movement of the mounting shaft into the tip. At this point the lobes have snapped under the locking ring on the collar and the stop has hit the circumferential shelf on the tip, thus providing the user tactile feedback not to use additional, excessive force to mount the tip. These interrelated mounting conditions result in a secure, stable mount with consistent sealing. While automated pipette systems do not rely on tactile feedback to determine when the tip is properly mounted, the configuration of assignee’s pipette tips and mounting shafts provides reliable, robust sealing. For example, if a tip rack bends when the tips are being mounted, the lobed-mounting shaft configuration helps to ensure that all the tips are properly mounted and at the appropriate height relative to the pipetting head.

While the above tip mounting system described in assignee’s incorporated patents and application has provided a significant advancement in the art, it is desirable to further lessen tip insertion forces. Reducing insertion forces is particularly important in automated systems where 96 or 384 tips are mounted simultaneously. For example, reducing peak insertion force by 2N per tips reduces the peak mounting force by 768 N when 384 tips are mounted together as is common in automated pipette systems. It is a primary object of the present invention to provide a reduction in the required insertion without substantially affecting the stability of the mounted pipette tips.

Co-pending patent application No. 19/365,815, entitled “Pipette Tip and Mounting Shaft with Offset Locking Feature” and filed on October 22, 2025, by Applicant of the present application, and incorporated by reference, discloses positioning the locking lobes on the mounting shaft with respect to the stop on the mounting shaft, so that the locking function is offset, and occurs prior to, the sealing function when the tip is mounted on the mounting shaft. This configuration has been found to reduce the peak insertion force compared to the prior art tips in which the locking function and the sealing function occurs contemporaneously. The present invention offsets the locking function and the sealing function but uses a different lobe configuration.

As mentioned previously, the prior tip mounting shaft in the incorporated patents and applications has three lobes spaced equally around the mounting shaft with recessed relief portions spanning between the lobes to accommodate inward distortion of the tip collar between the lobes. Using four lobes has been shown to increase the force required to insert the mounting shaft past the locking ring on the tip collar.

### SUMMARY OF THE INVENTION

The invention is directed to a pipette tip mounting shaft having four lobes in staggered pairs, which results in reduced insertion forces while also providing a stable fit for the disposable pipette tip on the mounting shaft.

The tip mounting shaft includes an upper locking section having a stop, and a sealing area located below the stop. The locking section has four outwardly extending lobes located above the stop, and spaced circumferentially around the locking section (e.g., 90-degree spacing). Each respective lobe has a peak spaced longitudinally above the stop on the mounting shaft. The lobes have an inclining ramp, a peak, and a declining ramp, and the distance between the peak of the lobes in the first pair of lobes to the stop is different from the distance between the peak of the lobes in the second pair of lobes to the stop. The first pair of lobes are on opposite sides of the mounting shaft (e.g. 180-degree spacing) and the lobes in the second pair are oriented 90-degrees from the lobes of the first pair. The staggered lobes reduce the required tip insertion force.

The disposable pipette tips have a barrel into which liquid is aspirated and dispensed for pipetting, and a collar for mounting the disposable pipette tips to the lobed mounting shaft. The collar has a continuous inner surface with a circular circumference in its relaxed state. The lower end of the collar has an inside diameter that is larger than an inside diameter of the upper end of the barrel. A circumferential tip shoulder connects the lower end of the collar to the upper end of the barrel. The structure and thickness of the circumferential tip shoulder maintains the roundness of the shoulder and the barrel below even if the collar is distorted out of round.

A locking ring extends inward from the inner surface of the collar to engage over the locking lobes. The locking ring extends around the entire circumference of the collar or substantially around the entire circumference of the collar and is located at a rim of the upper opening of the collar and above the circumferential tip shoulder. The collar is sufficiently flexible to distort outwardly at the lobes on the mounting shaft and inwardly at the recessed relief portions between the lobes when the pipette tip is being mounted on to the tip mounting shaft. The circumferential tip shoulder, as mentioned, maintains roundness as the collar is distorted out of round. When the tip mounting shaft is inserted into the collar of the disposable pipette tip, the locking ring engages the first pair of lobes on the mounting shaft and clears the peaks of the first pair of lobes on the mounting shaft before engaging the second pair of lobes and clearing the peaks of the second pair of lobes. The collar and the locking ring are therefore distorted out of round over the first pair of lobes and then distorted out of round over the second pair of lobes, which results in reduced force required to engage the locking ring on the collar over the four lobes on the mounting shaft.

The disposable tip seals against the sealing area below or at the stop on the mounting shaft similar to the sealing engagement in the above incorporated U.S. Pat. Appl. No. 18/601,304, entitled “Pipette Tip and Mounting Shaft,” U.S. Pat. Appl. No. 19/365,815 entitled “Pipette Tip and Mounting Shaft with Offset Locking Feature,” and U.S. Pat. Appl. No. 18/601,382, entitled “Pipette Tips and Rack System for Liquid Handling Equipment,” or alternatively in the incorporated U.S. Pat. Nos. 7,662,343, 7,662,344, an 8,277,757. The locking ring in the collar preferably clears the peaks of the lobes prior to completing sealing engagement between the mounting shaft and the tip, when mounting the tip on the mounting shaft. This configuration offsets the peak required insertion force for sealing from the peak force required for locking the tip collar onto the mounting shaft.

In the preferred embodiment of the invention, the declining ramps for the first pair of lobes slant away from the respective peak at different angle than the declining ramps for the second pair of lobes such that all four of the declining ramps meet the mounting shaft base at same distance from the stop. This way the locking ring on the mounted pipette tip settles against the mounting shaft at the base of all four declining ramps. The resilient collar is desirably close to the fully relaxed state when the tip is fully mounted with the locking ring settling at or near the bases of the declining ramps.

The means of sealing the pipette tip against the lower section of the tip mounting shaft can take several forms. In the preferred embodiment of the invention, a circular cantilever sealing ring is provided by an annular wall extending from the tip shoulder towards the collar opening, as described in incorporated U.S. Patent Nos. 18/601,304; 18/601,382 and 19/365,815. The annular wall laterally engages and seals against the sealing area of the mounting shaft when the tip is fully mounted to the mounting shaft. The annular wall preferably slants inward in its relaxed state as it extends from the circumferential tip shoulder toward the opening in the collar. A circumferential gap above the circumferential shoulder enables the annular wall to move laterally without stretching the circumferential shoulder when engaged by the mounting shaft. The annular wall has a top edge that abuts the stop on the pipette mounting shaft when the tip is fully mounted to the mounting shaft, which provides haptic feedback to the user of a handheld pipette that the tip is fully mounted. Preferably, the disposable pipette tip further includes a circumferential stabilization ring encircling the inside surface of the tip barrel. The stabilization ring extends inward from the inside surface of the barrel and is located below said sealing ring. The mounting shaft is desirably tapered to have a smaller diameter so that it does not seal or apply significant force at the stabilization ring during the mounting process. The inside surface of the annular wall forms an interference of 0.05 to 0.11 mm with the cylindrical sealing region on said mounting shaft. However, the slant of the inside surface of the annular wall continues as the surface extends downward to a zero-interference location and beyond to provide ample clearance between the inside surface of the pipette tip and the mounting shaft, until the tapered tip of the mounting shaft is supported laterally be the stabilization ring.

Alternatively, a circumferential ring encircling the inside surface of the barrel of the pipette tip and extending inward from the inside surface of the barrel can be used to seal the pipette tip against the lower section of the tip mounting shaft. Further, an O-ring ring on the mounting shaft below the stop can be used to facilitate sealing against the barrel of the tip or even against a cantilevered ring at the circumferential tip shoulder as described previously. In all these configurations, it is desirable that the disposable pipette tip have a circumferential stabilization ring encircling the inside surface of the barrel also as discussed previously.

Other features and advantages of the invention may be apparent to those skilled in the art upon reviewing the following drawings and description thereof.

### BRIEF DESCRIPTION OF THE DRAWINGS

FIG. 1 is a manually assisted 384-well robotic pipetting instrument using mounting shafts and pipette tips configured to offset engagement of the locking ring over mounting shaft lobes and the sealing of the tip against the mounting shaft, in accordance with the present invention.

FIG. 2 is a perspective view showing a disposable pipette tip and tip mounting shaft constructed in accordance with the invention.

FIG. 3 is a side elevational view of the mounting shaft and pipette tip shown in FIG. 2.

FIG. 4 is a longitudinal cross-section taken along line 4-4 in FIG. 3.

FIG. 5 is a detailed view of an area encircled by line 5-5 in FIG. 4 showing an upper locking collar, a circumferential shoulder, and a circular cantilevered sealing ring on the disposable pipette tip illustrated in FIGS. 2 and 4.

FIG. 6A is a detailed view of the area encircled by line 6-6 in FIG. 4 showing a locking section including a first pair of outwardly extending lobes, a cylindrical sealing section, and a stop of tip mounting shaft shown in FIGS. 2 and 4.

FIG. 6B is a detailed cross-section of the area encircled by line 6-6 in FIG. 4 and rotated 90° from the view shown in FIG. 6A showing the locking section including a second pair of outwardly extending lobes, the cylindrical sealing section, and the stop of the tip mounting shaft shown in FIGS. 2 and 4.

FIG. 7 depicts detailed side elevational views comparing peak locations of the first and second pairs of outwardly extending lobes of the tip mounting shaft shown in FIGS. 6A and 6B.

FIG. 8 depicts detailed side elevational views comparing declining ramp locations of the first and second pairs of outwardly extending lobes of the tip mounting shaft shown in FIGS. 6A and 6B.

FIG. 9 is a side elevational view showing the mounting shaft and pipette tip configured in accordance with the invention with the mounting shaft being inserted into the pipette tip and the inclining ramps of the first pair of outwardly extending lobes beginning to contact the locking ring on the inside surface of the tip collar.

FIG. 10 is a longitudinal quarter-sectional view taken partially along line 10-10 in FIG. 9 such that one lobe of a first pair of positioned 180° apart from each other is shown on the left side of the depicted mounting shaft and one lobe of a the second pair of lobes positioned 90° from each lobe in the first pair is shown on the right side of depicted mounting shaft.

FIG. 11A is a detailed quarter sectional view of the area encircled by line 11-11 in FIG. 10 showing the mounting shaft being inserted into the pipette tip and the inclining ramps of the first pair of outwardly extending lobes beginning to contact the locking ring on the inside surface of the tip collar.

FIG. 11B is a view similar to FIG. 11A in which the mounting shaft has been inserted deeper into the pipette tip such that the peaks of the inclining ramps of the first pair of outwardly extending lobes contact the locking ring on the tip collar and the inclining ramps of the second pair of outwardly extending lobes beginning to contact the locking ring on the tip collar.

FIG. 11C is a view similar to FIGS. 11A-11B in which the mounting shaft has been inserted deeper into the pipette tip such that peaks of the inclining ramps of the first pair of outwardly extending lobes have passed over the locking ring on the tip collar and the peaks of the inclining ramps of the second pair of outwardly extending lobes contact the locking ring on the tip collar.

FIG. 11D is a view similar FIGS. 11A-11C in which the mounting shaft has been inserted deeper into the pipette tip such that peaks of the inclining ramps of both the first and second pairs of outwardly extending lobes have passed over the locking ring on the tip collar and the mounting shaft has not yet engaged the cantilevered circular seal on the tip.

FIG. 11E is a view similar to FIGS. 11A-11D in which the mounting shaft has been inserted deeper into the pipette tip such that the mounting shaft is engaged with the cantilevered circular seal on the pipette tip and the stop on the mounting shaft reaches and abuts the tip.

FIG. 12 is a plot of peak force data for pipette tip when mounted on a four lobed mounting shaft with staggered offset engagement in accordance with the invention compared to a mounting shaft configured simultaneous engagement in accordance with the prior art.

### DETAILED DESCRIPTION

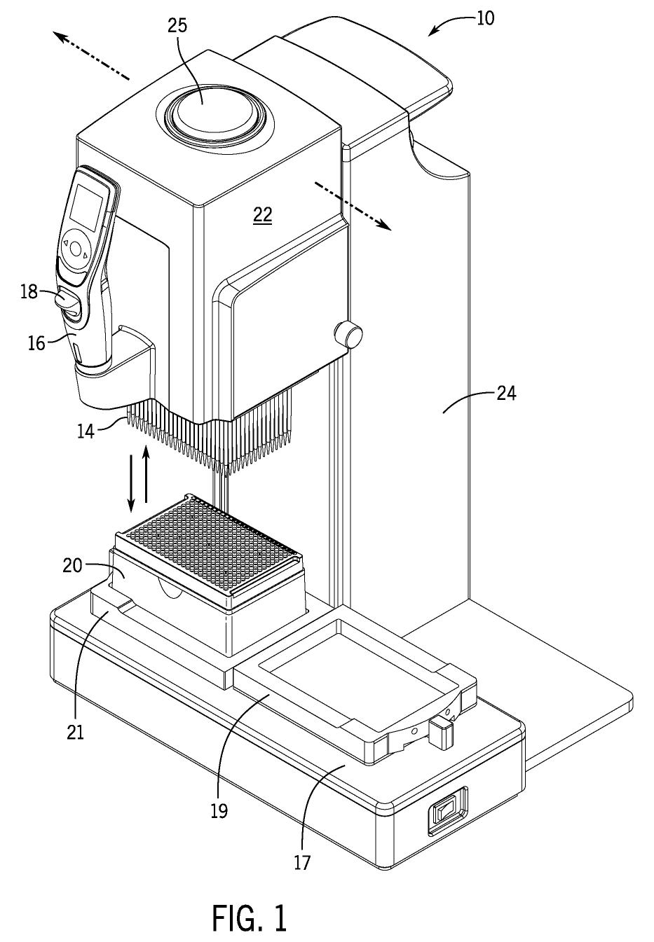

FIG. 1 illustrates a manually directed, 384-channel robotic pipetting system 10. Specifics of how the robotic pipetting system 10 operates are disclosed in U.S. Pat. No. 8,367,022, entitled “Unintended Motion Control for Manually Directed Multi-Channel Electronic Pipettor,” by Warhurst et al., issuing on Feb. 5, 2013 and incorporated herein by reference; and U.S. Pat. No. 8,372,356, entitled “Manually Directed, Multi-Channel Electronic Pipetting System,” by Warhurst et al., issuing on Feb. 12, 2013 and also incorporated herein by reference. Briefly, the robotic pipetting system 10 is shown with an array of 384 disposable pipette tips 14 mounted onto an array (16 x 24) of mounting shafts 12 on a pipetting head attached to the system 10. The tip mounting shafts 12 and the disposable pipette tips 14 are constructed as discussed below. When mounting an array of pipette tips 14 simultaneously onto an array of mounting shafts 12, the required cumulative insertion force is significantly greater than with a single channel, handheld pipette or even an 8-, 12- or 16-channel handheld pipette. In fact, the cumulative insertion force to attach 384 tips simultaneously is significantly more than 96 tips. The robotic pipetting system 10 in FIG. 1 has a vertical drive mechanism that is used to raise and lower the pipetting head and generate enough force for simultaneous insertion into 96 or 384 tips. It is known in robotic pipetting systems, whether manually directed like the system 10 in FIG. 1, or fully automated like many other laboratory liquid handling systems, to have a vertical drive mechanism to raise and lower the pipetting head with enough force to simultaneously mount 96 or 384 pipette tips.

The robotic pipetting system 10 in FIG. 1 has a flat deck 17 supporting a right-side nesting receptacle 19 and a left-side nesting receptacle 21. The nesting receptacles 19, 21 are designed to hold microtiter plates, reagent reservoirs, or pipette tip racks in known locations on the deck 17. The nesting receptacles 19, 21 desirably have dimensions defined by SBS standards as is known in the art. FIG. 1 shows a pipette tip rack system 20 in the left-side nesting receptacle 21. The pipette tip rack 20 holds 384 pipette tips which in FIG. 1 have been mounted to a pipetting head attached to the carriage 22 of the robotic pipetting system 10. The carriage 22 in turn is mounted to a tower 24. In some systems, the pipetting head is replaceable, which would enable the customer to switch between 384 and 96 channel heads if desired. A pipetting motor located within the carriage 22 drives the multi-channel pipetting head to aspirate and dispense. A Z-axis vertical drive mechanism moves the carriage 22 and the multi-channel pipetting head vertically with respect to the tower 24 and the deck 17. An X-axis drive mechanism moves the tower 24 and the carriage 22 horizontally along an X-axis so that the pipetting head and the array of tips 14 can be moved over the right-side nesting receptacle 17 on the deck 16 or over the left-side nesting receptacle 21 on the deck 17.

The system 10 includes a control handle 16 mounted to the carriage 22 and resembling a handle for a handheld electronic pipette. In use, the user grasps the control handle 16 in a manner similar as when using a handheld pipette and exerts pressure on the control handle 16 to move the carriage 22 and the pipetting head. The vertical Z-axis motion and the horizontal X-axis motion are driven by independent motors under servo control. The control handle 16 in system 10 also includes a user interface for controlling pipetting functions such as aspirating and dispensing.

To mount the pipette tips, the pipetting head with the array of tip mounting shafts is aligned precisely over the tip rack 20 located on deck 17 using the X-axis horizontal drive mechanism. Then, the Z-axis vertical drive mechanism is used to lower the carriage 22 and the tip mounting shafts 12 with sufficient force to attach the array of pipette tips 14 held in the pipette tip rack 20. The carriage 22 and the pipetting head are then raised using the Z-axis vertical drive mechanism to remove the tips 14 from the tip rack 20. The tip rack 20 is removed from the nesting receptacle 21 on the deck 16 and replaced with a well plate or reservoir in order to transfer fluids.

For tip attachment as with regular motion control, the general horizontal and vertical motion of the carriage 22 and pipetting head is controlled by the user by holding the controller 16 in their palm and applying pressure in the appropriate direction to position the pipetting head over the rack 20 of pipette tips 14. Biasing motion control software can be used to achieve precise alignment necessary for tip attachment. Once the pipetting head and the tip mounting shafts 12 are aligned, the handle control 16 is disabled and an automated tip attachment routine is used to provide sufficient downward force to attach the tips 14 to the mounting shafts 12. As a safety precaution, the automated tip attachment routine can be activated only when one of the user’s hands depresses the button 25 on the top of the carriage 22 and the other hand is detected to be present on the handle 16.

Once the tips 14 are mounted, internal components in the carriage 22 drive pistons that each extend through a seal assembly to displace air within an aspiration and dispensing cylinder. The tip mounting shafts 12 are attached to the pipetting head such that each shaft is in fluid communication with one of the aspiration and dispensing chambers. The user interface on the handle 16 includes thumb wheel control, run button and a display. The handle 16 also includes a lever or ejection button 18 that is pushed downward to activate downward movement of an ejection plate on the pipette head. The ejection plate is desirably stepped so that the tips are ejected in stages thereby reducing the required ejection force.

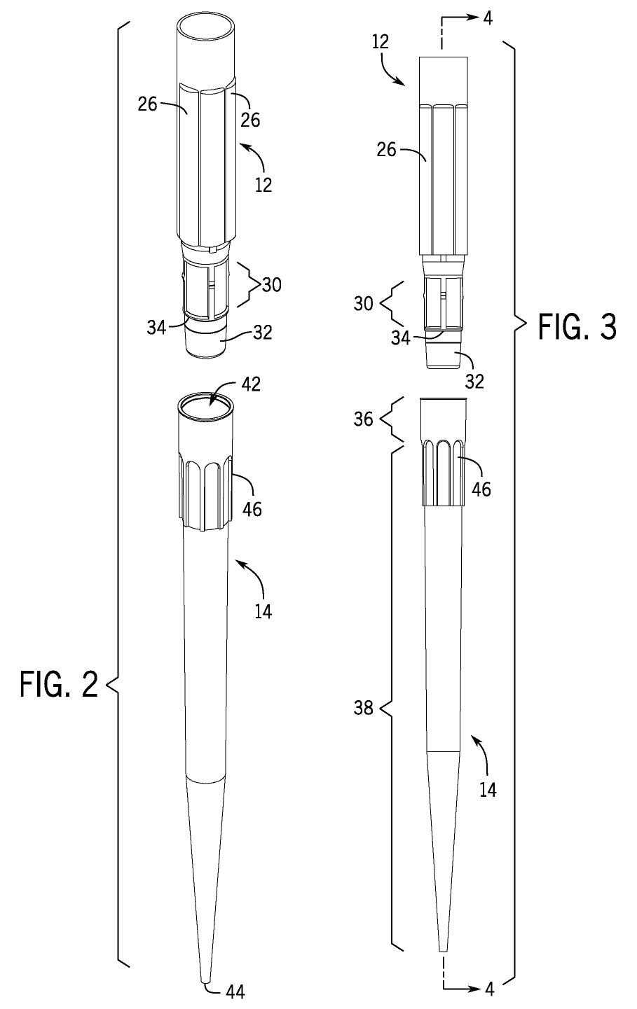

The invention pertains to reducing the peak insertion force, which is useful in automated systems since the cumulative insertion force of 384 or 96 pipette tips can be significant but reducing insertion force is also useful for handheld pipettes for ergonomic reasons. The mounting shaft 12 and pipette tip 14 illustrated in FIGS. 2 through 8 provide low insertion forces, and robust reliable sealing in accordance with a first embodiment of the present invention. The invention in this first embodiment pertains to a modification made to the relative dimensions of mounting shaft and pipette tip described in the incorporated, co-pending ‘304 and ‘382 applications.

As shown in FIG. 2, the mounting shaft 12 includes a plurality of mounting protrusions 26 for attaching it to the lower end of the aspiration and dispensing cylinder (not shown) on the pipetting head of the robotic liquid handling system 10, or a handheld pipette. In FIGS. 2 through 8, as in the incorporated, co-pending ’304 and ’382 applications, the dimensions of the mounting shaft 12 match the dimensions of the pipette tip 14 so that only pipette tips 14 with the proper dimensions fit onto the mounting shaft 12 and engage properly. For example, even if the pipette tips are constructed in accordance with the invention, if one chooses to use pipette tips with a different bore dimension in the collar or sealing region, it is necessary to replace the pipetting head with a new pipetting head with mounting shafts 12 having appropriate dimensions for the tips 14 being mounted and used.

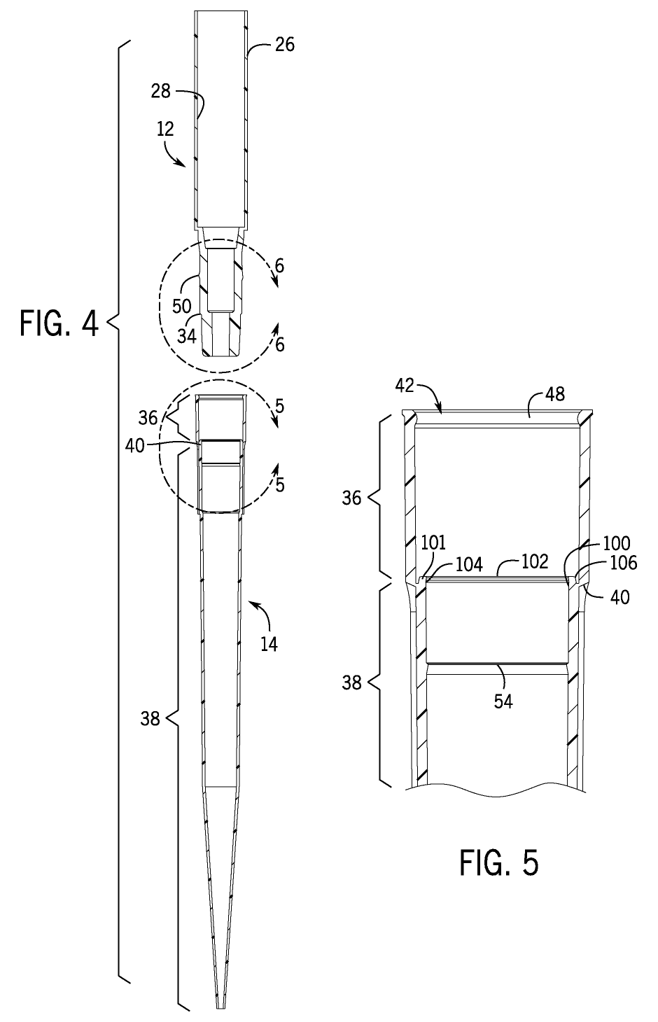

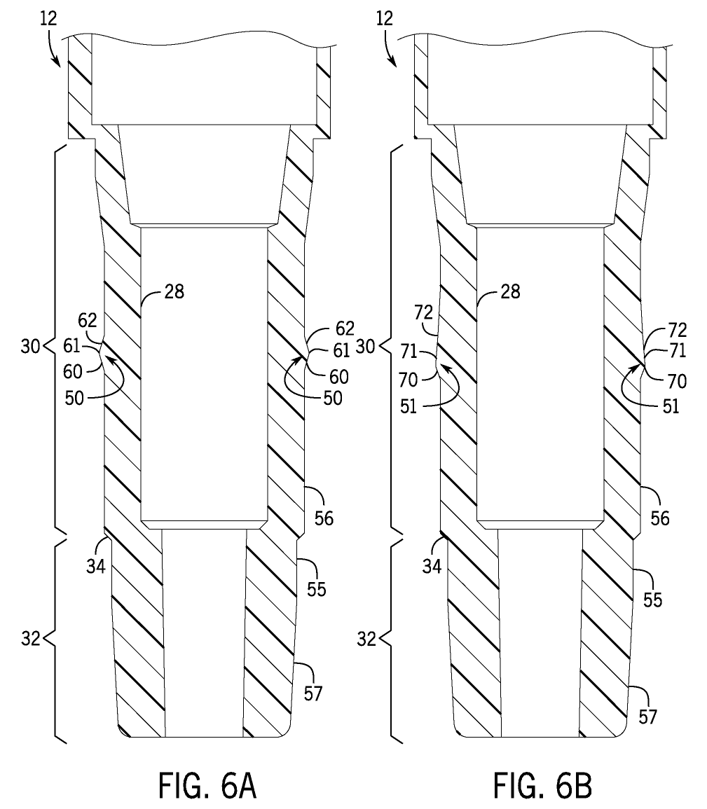

Referring now in general to FIGS. 2-8, the mounting shaft 12 contains a central bore 28 (FIG. 4) for air to pass between the aspiration and dispensing cylinder in the pipette 10 and the pipette tip 14, as is well known in the art. The pipette mounting shaft 12 includes an upper locking section 30, a lower section 32, and a stop 34 located between the upper locking section 30 and the lower section 32. Sealing occurs in the area 55 (see FIGS. 6A and 6B) of the lower section 32 on the mounting shaft 12 immediately below the stop 34 (see FIGS. 6A and 6B). The locking section 30 of the mounting shaft 12 has a first pair of outwardly extending locking lobes 50 (see FIG. 6A), a second pair of outwardly extending locking lobes 51 (see FIG. 6B), and recessed areas 58 spanning between the locking lobes 50, 51.

The pipette tip 14 generally consists of a collar 36, a barrel 38, and a circumferential shoulder 40 (see e.g., FIGS. 4 and 5) that extend around the inside bore of the tip 14 and connects the lower end of the collar 36 to the upper end of the barrel 38. The upper end of the collar 36 has an opening 42 to receive the pipette mounting shaft 12. The lower end of the barrel 38 has a small opening 44 through which liquid is aspirated into the tip barrel 38 and dispensed from the tip barrel 38 during normal operation of the pipette 10. Support ribs 46 (see FIGS. 2 and 3) extend downward on the outside surface of the disposable tip 14 from the collar 36. The support ribs 46 function to hold the tip 14 or an array of tips 14 in a rack for subsequent use and mounting, as is known in the art.

Referring to FIG. 5, a circumferential locking ring 48 is located on the inside surface of the collar 36 of the pipette tip 14. The locking ring 48 is located at or slightly below the opening 42 in the collar 36 through which the mounting shaft 12 is inserted. The locking ring 48 extends inward from the inside wall of the collar a slight amount, e.g. in the range of 0.025 to 0.25 mm, in order to provide an over-center locking fit over respective peaks 61, 71 of the first and second pairs of locking lobes 50, 51 on the mounting shaft 12 (see FIGS. 6A and 6B). The inside surface of the collar 36 is substantially cylindrical but preferably has a slight drat to facilitate molding. The preferred taper is between 0° and 10°. In any event, horizontal cross-sections through the main section of the collar 36 are circular.

As mentioned, the circumferential shoulder 40 on the tip 14 connects the lower end of the collar 36 to the upper end of the barrel 38. A circular cantilever sealing ring 100 includes a resilient annular wall 101 that extends from the tip shoulder 40 towards the collar opening 42. The purpose of the laterally resilient annular wall 101 is to laterally engage and seal against the cylindrical sealing area 55 (see FIGS. 6A and 6B in which the lead line for 55 points to the lower boundary of the cylindrical area) on the mounting shaft 12 when the tip 14 is fully mounted to the mounting shaft 12. The annular wall 100 has an upper free end 102 that abuts the stop 34 on the pipette mounting shaft 12 when the tip 14 is fully mounted to the mounting shaft 12. This lateral seal is sometimes referred to as a reverse cup seal.

The collar 36 of the disposable pipette tip 14 is sufficiently flexible to distort outwardly at the lobes 50, 51 on the mounting shaft 12 and inwardly at the recessed relief portions 58 on the mounting shaft between the lobes when the pipette tip 14 is mounted on the tip mounting shaft 12. However, the circumferential shoulder 40 has sufficient structural integrity to maintain roundness of the circular cantilever sealing ring 100 so that an inside surface 104 of the of the annular wall 101 seals laterally against the sealing area 55 of the mounting shaft 12.

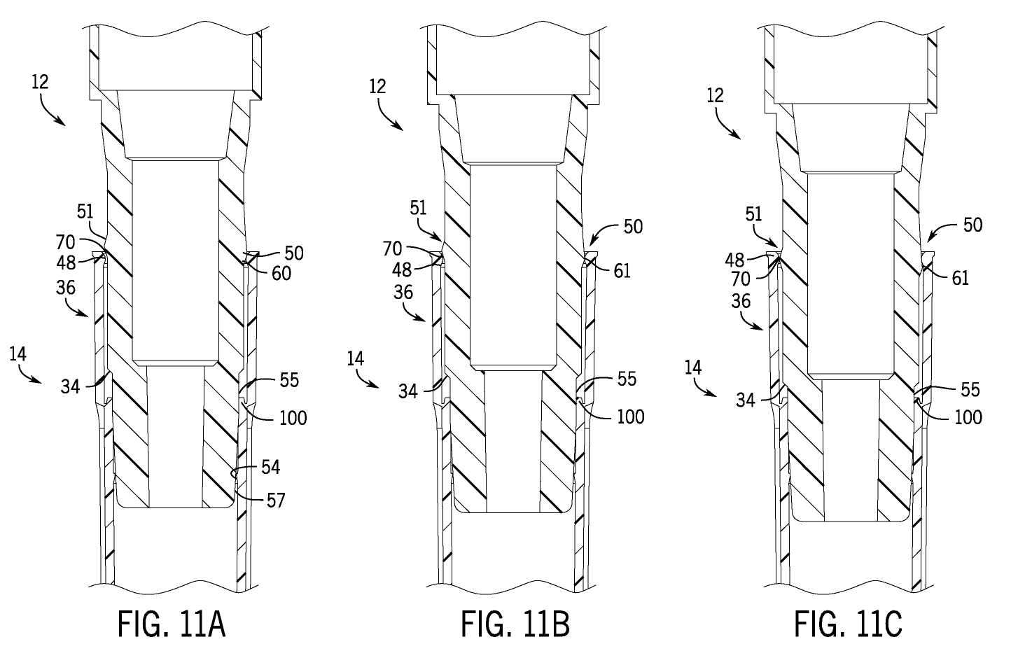

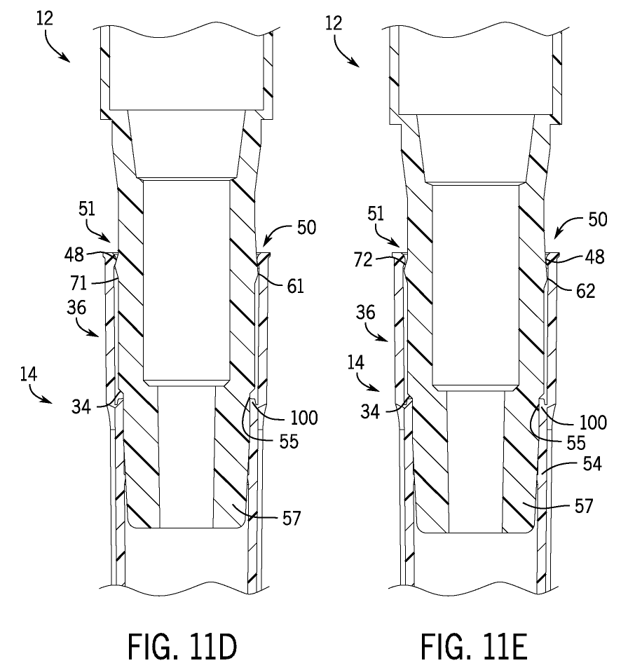

The circumferential shoulder 40 as shown in FIG. 5 is continuous around the circumference of the tip 14. The shoulder 40 is shown to be angular in cross section, however, it need not be angular. The circumferential shoulder 40 provides structural integrity that serves to separate and isolate the distortion of the collar 36 from the circular cantilever sealing ring 100. The collar 36 is distorted out-of-round when the mounting shaft 12 is inserted into the pipette tip 14, although as depicted in FIG. 11E the collar 36 is in a relaxed state when the mounting shaft 12 is fully inserted. The circumferential shoulder 40 of the tip 14 isolates the circular cantilever sealing ring 100 from any distortion, thereby facilitating an effective lateral seal between the inside surface 104 of the annular wall 101 of the circular sealing ring 100 on pipette tip 14 and sealing region 55 on the mounting shaft, see incorporated ’304 and ’832 applications.

Referring again to FIG. 5, to accurately locate the mounting height of the tip 14 on the mounting shaft 12 when the tip 14 is fully mounted to the mounting shaft 12, the stop 34 on the mounting shaft 12 engages the top edge 102 of the annular wall 101 of the circular cantilever sealing ring 100. With multi-channel devices, this configuration ensures the same vertical mounting distance from tip to tip, which facilitates precise and consistent tip positioning during pipetting. When the tip 14 is in a relaxed state, the inside circumferential surface 104 of the annular wall 101 angles slightly inward as the annular wall 100 extends upward towards the collar opening 42. The slight inward slant provides a lateral interference fit between the inside surface 104 of the annular wall 101 and the cylindrical sealing region 55 of the mounting shaft 12 when the mounting shaft 12 is fully inserted. In a preferred embodiment, the amount of interference ranges from 0.05 to 0.11 mm. The annular wall 101 extends upward above the circumferential shoulder 40 such that there is a gap 106 between the annular wall 101 and the collar sidewall 36. The gap 106 enables the annular wall 100 to pivot outward laterally when the pipette mounting shaft 12 is inserted into the tip 14. The inside diameter of the tip immediately below the annular wall 101 is selected to have zero interference with the mounting shaft 14. Rather, the lateral interference fit of the annular wall 101 of the circular cantilever sealing ring 100 above the shoulder 40 of the tip 14 provides the sealing engagement of the tip 14 to the mounting shaft 12.

Referring now to FIGS. 6A and 6B, cross-sectional views bisecting the first and second pairs of lobes 50, 51 of the mounting shaft 12 are respectively depicted. The locking section 30 of the mounting shaft 12 has a central cylindrical aligning section 56 located immediately above and adjacent the stop 34. When the pipette tip 14 is mounted on the mounting shaft 12, the central cylindrical aligning section 56 on the on the mounting shaft 12 helps to maintain the tip 14 in a straight orientation; however, there is preferably clearance between the collar sidewall 36 of tip 14 and central cylindrical aligning section 56 when the tip 14 is mounted on the mounting shaft 12. The diameter of the mounting shaft 12 decreases (e.g., steps down) at the stop 34 between the cylindrical section 56 above the stop 34 and the sealing section 55 below the stop 34. The reduction in shaft diameter at the stop 34 is generally commensurate with the reduction in diameter of the matching pipette tip 14 at its circumferential shelf 40. This reduction is preferably in the range of about 0.1 to 1.0 mm. It is not necessary that the cylindrical aligning section 56 be continuous around the circumference of the mounting shaft 12 inasmuch as the purpose is to provide secure, stable locking engagement of the pipette tip 14 on the mounting shaft 12 and not to provide a seal in this region. In this regard, the configuration of the mounting shaft 12 is similar to that disclosed, e.g., in the following above incorporated U.S. Patent Nos. 7,662,343; 7,662,344; 8,277,757; 8,501,118; 8,877,513 and 9,333,500, which are owned by the assignee of the present application.

Above the cylindrical aligning section 56, the top of the locking section 30 of the mounting shaft 12 includes a first pair of locking lobes 50 (see FIG. 6A) and a second pair of locking lobes 51 (see FIG. 6B) circumferentially spaced evenly around the mounting shaft 12. Each of the first and second pairs of lobes 50, 51 includes relatively gently sloping inclining ramps 60, 70. The preferred slope of each of the inclining ramps 60, 70 with respect to the vertical axis of the mounting shaft is between 10° and 20°. The first pair of lobes 50 angle outward as the inclining ramps 60 extend toward peak portions 61 of the lobes 50. Each in the first pair of lobes 50 also includes a declining ramp 62 which slopes inward as the declining ramp 62 extends upward away from the peak portion 61. Similarly, the second pair of lobes 51 angle outward as the inclining ramps 70 extend toward peak portions 71 of the lobes 51. Each in the second pair of lobes 51 also include a declining ramp 72 which slopes inward as the declining ramp 72 extends upward away from the peak portion 71. Each of the peak portions 61, 71 is preferably curved and has a radius of between 0.15 and 0.38 mm. At the peak portions 61, 71 of both pairs of lobes 50, 51, it is preferred that the lobes extend outward beyond the outer surface of the cylindrical aligning section 56, although the exact preferred dimensions will depend on the amount of taper of the collar 36 in the corresponding matching pipette tip as well as the tip wall thickness.

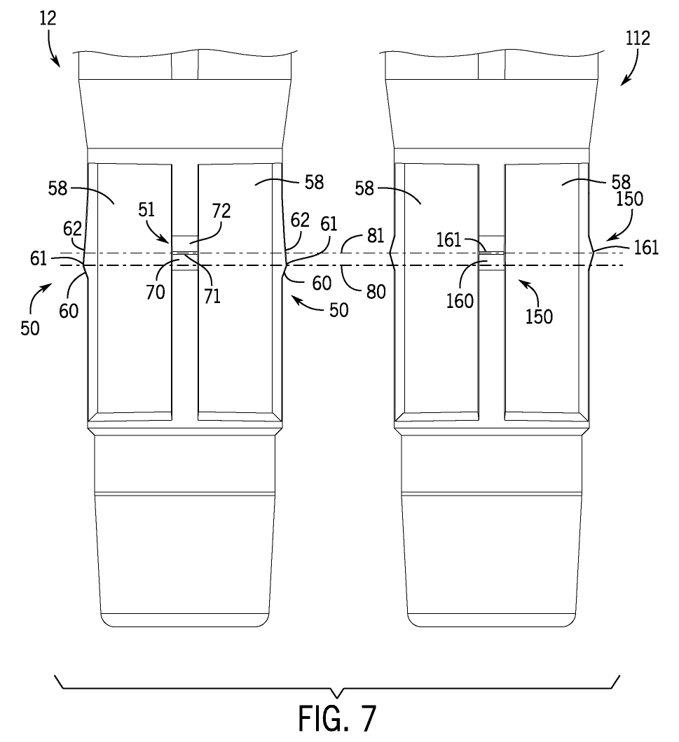

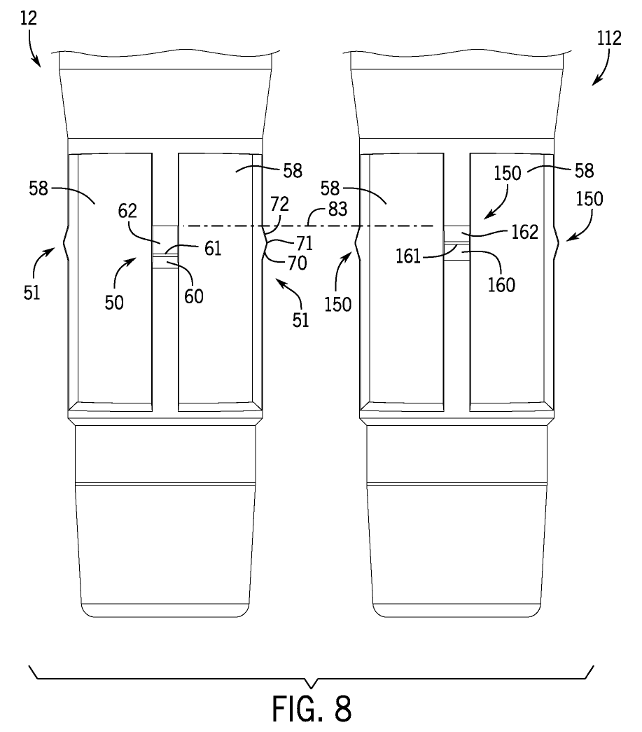

FIGS. 7 and 8 each depict the mounting shaft 12 of the present disclosure in comparison with a mounting shaft 112 having locking lobes 150 that are not offset from each other and do not therefore reduce the force required to engage the locking ring on the collar over the four lobes on the mounting shaft. Each of the non-offset locking lobes 150 is shown to include an inclining ramp 160, a peak portion 161, and a declining ramp 162. As shown in FIGS. 7 and 8, the inclining ramps 60 of the first pair of lobes 50 begin closer to the stop 34 on the mounting shaft 12 than the inclining ramps 70 of the second pair of lobes 51. Accordingly, the peak portions 61 of the first pair of lobes 50 are located closer to the stop 34 on the mounting shaft 12 than the peak portions 71 of the second pair of lobes 51. This discrepancy is best shown in the gap between line 80, which is shown to pass through the peak portions 61 of the first pair of lobes 50, and line 81, which is shown to pass through the peak portion 71 of the second pair of lobes 51 and peak portion 161 of the lobes 150 on the mounting shaft 112. In exemplary embodiment, the distance between the peak portions 61 and 71 (i.e., the dimension of the gap between lines 80 and 81) is .0285 in = .72 mm, although modifying the dimension of the gap between lines 80 and 81 may result in suitable reduction of insertion force to implement the invention particularly if tip and lobe dimensions are generally different from that depicted in the exemplary embodiment. As described above and as depicted below in FIGS. 11A-11E, by offsetting the peak locations 61 and 71 of the first and second pairs of lobes 50, 51, the peak locations interact with the tip locking ring 48 at different times during the insertion process, and force amplification from the lobes 50, 51 is reduced.

The inventor has recognized that offsetting the inclining ramps 60 and 70 is desirable to achieve offset locations of the corresponding peak locations 61 and 71. However, as best depicted in FIG. 8, the declining ramps 62 and 72 may be provided at different angles from each other, such that each of the declining ramps 62 and 72 terminates at the same location on the mounting shaft 12 (this is further illustrated via line 83, extending to the edge of the declining ramp 162 of non-offset lobes 150). In this way, the top edges of each of the first and second pairs of lobes 50, 51 are positioned in the same location to ensure that the mounting shaft 12 is securely fastened to the pipette tip 14 when the stop 34 on the mounting shaft 12 abuts the top of the seal 100 on the pipette tip 14 (see FIG. 11E).

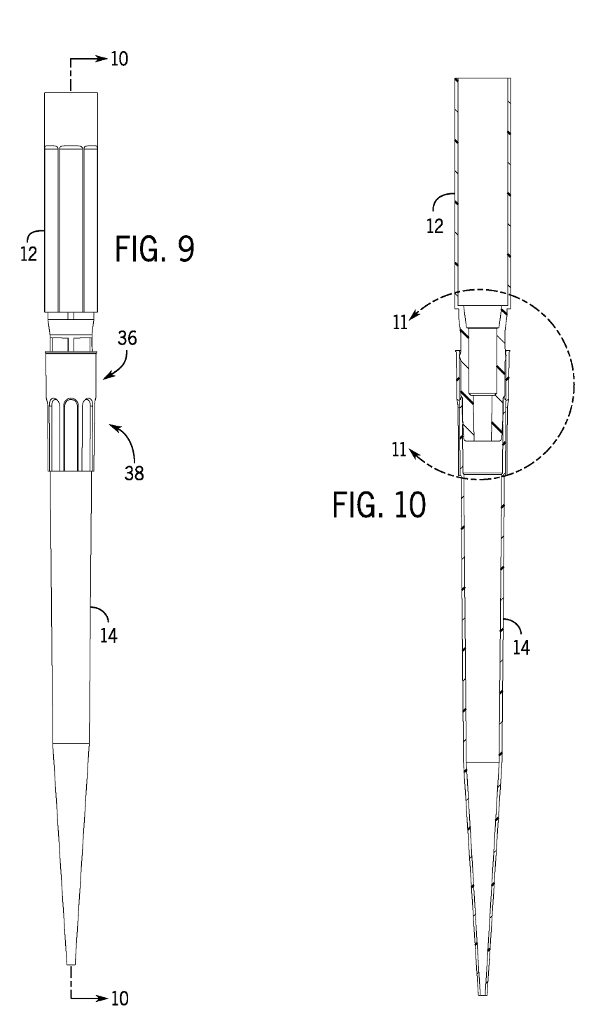

FIGS. 9 and 10 respectively depict elevation and quarter-sectional views of the insertion of the mounting shaft 12 into the pipette tip 14 (note: FIGS. 10 and 11A-11E depict quarter-sectional views such that the first and second pairs of lobes 50, 51 are visible in the same view even though the first pair of lobes 50 are positioned 180° apart from each other and the second pair of lobes 51 are positioned 90° from each of the first pair of lobes 50). FIGS. 11A through 11E illustrate stages of the insertion of the mounting shaft 12 into the pipette tip 14. FIG. 11A is a drawing showing a mounting shaft 12 and pipette tip 14 configured in accordance with the first embodiment of the invention with the mounting shaft 12 starting to be inserted into the pipette tip 14. The first pair of locking lobes 50 on the mounting shaft 12 have just started to contact a locking ring 48 on the inside surface of the tip collar 36. More particularly, the inclined ramps 60 of the first pair of lobes 50 on the mounting shaft 12 are starting to engage the locking ring 48 on the tip collar 36 and are about to distort it out of round as insertion proceeds further. The inclined ramps 70 of the second pair of lobes 51 have not yet engaged the locking ring 48. The sealing region 55 on the mounting shaft 12 also has not engaged the cantilevered circular seal 100 on the pipette tip in FIG. 11A. A stabilizing ring 54 in the barrel of the tip 14 maintains alignment of the tip 14 but a seal is not formed with the lower region 57 of the mounting shaft 12 below the cylindrical sealing region 55.

FIG. 11B is a view similar to FIG. 11A in which the mounting shaft 12 has been inserted deeper into the pipette tip 14 such that the peaks 61 of the first pair of lobes 50 on the mounting shaft 12 are passing over the locking ring 48 on the tip collar 36 and the inclined ramps 70 of the second pair of lobes 51 are starting to engage the locking ring 48. FIG. 11C shows the mounting shaft 12 inserted deeper into the pipette tip 36 such that the peaks 61 of the first pair of lobes 50 on the mounting shaft 12 have passed over the center of the locking ring 48 on the tip collar 36 and the peaks 71 of the second pair of lobes 51 are contacting the center of the locking ring 48. In FIG. 11C, the sealing region 55 on the mounting shaft 12 has still not engaged the seal 100 on the pipette tip 36.

FIG. 11D shows the mounting shaft 12 at an insertion depth such that both the peaks 61, 71 of the first and second pairs of lobes 50, 51 have passed over the center of the locking ring 48. FIG. 11E shows the mounting shaft 12 inserted to the full depth such that the stop 34 on the mounting shaft 12 abuts the top of the seal 100 on the pipette tip 14, and the seal 100 seals laterally against the sealing area 55 immediately below the stop 34. As depicted in FIG. 11E, the collar 36 is fully relaxed and not distorted. It is contemplated that the invention can be implemented with the relative dimensions selected so that the locking ring 48 on the tip collar 36 is positioned on the declining ramps 62, 72 of the both the first and second pairs of lobes 50, 51 of the mounting shaft 12 when the tip 14 is fully mounted.

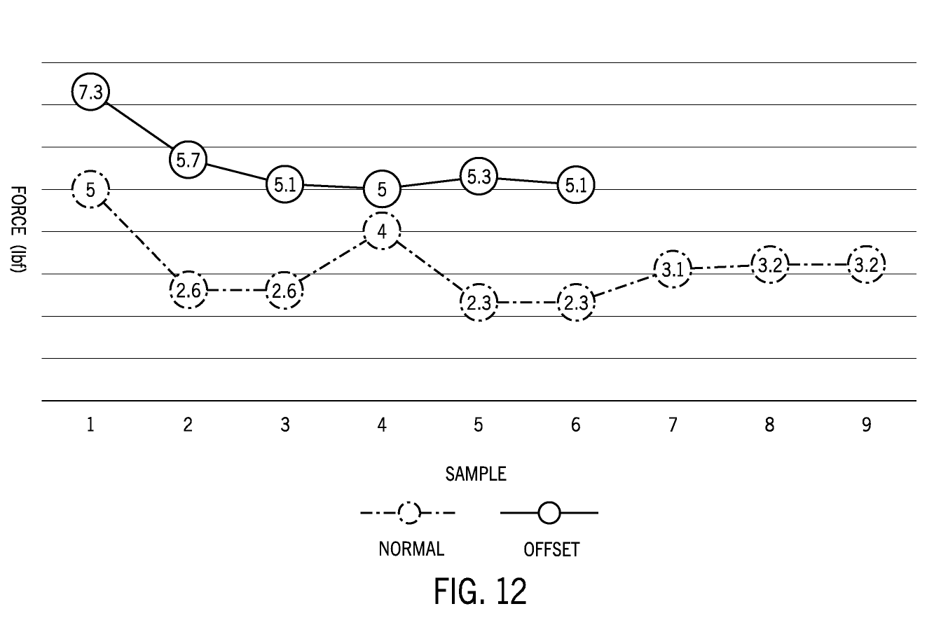

FIG. 12 shows peak force data in pounds for mounting 300 μL pipette tips. The 300 μL pipette tips were measured in a laboratory environment using a digital force meter and a test stand. The top curve shows force data when the 300 μL pipette tips are mounted on a mounting shaft with four lobes and a stop configured for simultaneous engagement. The bottom curve shows force data when the 300 μL pipette tips are mounted on a four-lobed mounting shaft with staggered offset engagement in accordance with the invention. The data shows that the staggered offset configuration requires significantly less insertion force than the simultaneous engagement configuration.

1. A pipette system comprising a tip mounting shaft and a disposable pipette tip, wherein the tip mounting shaft comprises:
an upper locking section having a stop, four outwardly extending lobes located above the stop and spaced circumferentially around the locking section of the mounting shaft, and recessed relief portions spanning circumferentially between the lobes and recessed relative to the lobes, each respective lobe having a peak being spaced longitudinally above the stop on the mounting shaft, and said tip mounting shaft also including a sealing area located below the stop, wherein the four outwardly extending lobes comprise a first pair of lobes and a second pair of lobes, wherein each lobe has an inclining ramp, a peak, and a declining ramp, and the distance between the peak of the lobes in the first pair of lobes to the stop is different from the distance between the peak of the lobes in the second pair of lobes to the stop; and
the disposable pipette tip comprises:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential tip shoulder connecting the lower end of the collar to the upper end of the barrel;
a locking ring extending inward from the continuous inner surface of the collar to engage the locking lobes, said locking ring extending around the entire circumference of the collar or substantially around the entire circumference of the collar and located at a rim of the upper opening of the collar and above the circumferential shoulder;
means for sealing against sealing area on the mounting shaft below the stop on the mounting shaft;
wherein the collar of the disposable pipette tip is sufficiently flexible to distort outwardly at the lobes on the mounting shaft and inwardly at the recessed relief portions on the mounting shaft between the lobes when the pipette tip is being mounted on to the tip mounting shaft, and further when the tip mounting shaft is inserted into the collar of the disposable pipette tip to mount the disposable pipette tip to the tip mounting shaft, the locking ring in the collar of the disposable pipette tip engages the first pair of lobes and clears the peaks of the first pair of lobes on the tip mounting shaft before engaging the second pair of lobes and clearing the peaks of the second pair of lobes.

2. The pipette system as recited in claim 1 wherein the declining ramps for the first pair of lobes slant away from the respective peak at different angle than the declining ramps for the second pair of lobes such that each of the declining ramps meets the base of the mounting shaft at the same distance from the stop.

3. The pipette system as recited in claim 1 wherein the peaks of the first pair of lobes are located closer to the stop on the mounting shaft than the peaks of the second pair of lobes, and the peaks of the first pair of lobes engage the locking ring on the collar of the pipette tip before mounting shaft engages the means for sealing against sealing area on the mounting shaft below the stop on the mounting shaft, when the pipette tip is being mounted to the mounting shaft.

4. The pipette system as recited in claim 1 wherein the peaks of the first pair of lobes are located closer to the stop on the mounting shaft than the peaks of the second pair of lobes, and the peaks of the first pair of lobes and the peaks of the second pair of lobes engage the locking ring on the collar of the pipette tip before the mounting shaft engages the means for sealing against sealing area on the mounting shaft below the stop on the mounting shaft, when the pipette tip is being mounted to the mounting shaft.

5. The pipette system as recited in claim 1 wherein said sealing means for sealing the pipette tip against the lower section of the tip mounting shaft comprises a circular cantilever sealing ring having an annular wall extending from the tip shoulder towards the collar opening for laterally engaging and sealing against the sealing area of the mounting shaft when the tip is fully mounted to the mounting shaft, said annular wall having a having a top edge that abuts the stop on the pipette mounting shaft when the tip is fully mounted to the mounting shaft.

6. The pipette system as recited in claim 5 wherein the disposable pipette tip further comprises a circumferential stabilization ring encircling the inside surface of the barrel and extending inward from the inside surface of the barrel, said circumferential stabilization ring being located below said sealing means for sealing the disposable pipette tip.

7. The pipette system as recited in claim 5 wherein an inside surface of the annular wall slants inward in its relaxed state as it extends from the circumferential shoulder toward the opening in the collar.

8. The pipette system as recited in claim 7 wherein an inside surface of the annular wall forms an interference of 0.05 to 0.11 mm with a cylindrical sealing region on said mounting shaft.

9. The pipette system as recited in claim 7 wherein the slant of the inside surface continues as the surface extends downward to a threshold location for zero interference location and beyond the threshold location to provide ample clearance between the inside surface of the pipette tip and the mounting shaft below the threshold location.

10. The pipette system as recited in claim 5 wherein the circular cantilever sealing ring on the pipette tip further comprises a circumferential gap above the circumferential shoulder between the annular wall of the circular cantilever sealing ring and the tip collar.

11. The pipette system as recited in claim 1 wherein said sealing means for sealing the pipette tip against the lower section of the tip mounting shaft comprises a circumferential ring encircling the inside surface of the barrel of the pipette tip and extending inward from the inside surface of the barrel.

12. The pipette system as recited in claim 1 wherein the locking ring on the pipette tip is substantially, continuously circumferential with a void that provides an opening that vents when the pipette tip is fully mounted on the mounting shaft.

13. The pipette system as recited in claim 1 wherein said sealing means on the upper portion of the tip barrel for sealing the pipette tip against the lower sealing section of the tip mounting shaft when the disposable pipette tip is mounted on the tip mounting shaft comprises an upper portion of the inside surface of the barrel adapted to engage an O-ring on the tip mounting shaft, and the disposable pipette tip further comprises a circumferential stabilization ring encircling the inside surface of the barrel and extending inward from the inside surface of the barrel.

14. The pipette system as recited in claim 1 wherein the disposable pipette tip further comprises a circumferential stabilization ring encircling the inside surface of the barrel and extending inward from the inside surface of the barrel, said circumferential stabilization ring being located below said sealing means for sealing the disposable pipette tip.

15. The pipette system as recited in claim 1 wherein the pipette tip is made of molded polypropylene.
